(19) United States
(12) Patent Application Publication
(10) Pub. No.: US 2009/0148155 A1
(43) Pub. Date: Jun. 11, 2009

(54) OPTIMIZED CDR APPLICATION FOR VARIABLE DATA RATE SIGNALS IN SFPs FOR JITTER REDUCTION

(76) Inventor: Ryan S. Latchman, Markham (CA)

Correspondence Address: PATENT GROUP 2N;JONES DAY, NORTH POINT, 901 LAKESIDE AVENUE, CLEVELAND, OH, 44114, US

(21) Appl. No.: 11/951,427

(22) Filed: Dec. 6, 2007

(51) Int. Cl. G02F 1/00; H04B 10/00

(52) U.S. Cl. 398/2; 398/155

(57) ABSTRACT

Systems and methods for conditioning an optical signal are provided for applications which require management of both low and high-data-rates. Upon receipt of a data signal, a determination is made as to whether the data signal is a high or low-data-rate signal. If the data signal is a high-data-rate signal, a clock and data recovery circuit is activated along the data path. If the data signal is a low-data-rate signal, the clock and data recovery circuit is bypassed. When activated, the clock and data recovery circuit conditions the data signal to reduce jitter and other distortion effects which tend to produce larger detrimental effects as data rates increase.

### BACKGROUND

1. Field of Invention

The technology described in this patent application relates generally to transmission and receiving of data signals, and in particular to the reduction of jitter in data signals which display varying data rates.

2. Related Art

Jitter is an unwanted variation of one or more signal characteristics in telecommunications. Jitter may be seen in characteristics such as the interval between successive pulses, or the amplitude, frequency, or phase of successive cycles. Jitter is a significant factor in the design of almost all high-speed communications links. The effects of jitter can be seen by comparing the eye diagrams of FIG. 1a and FIG. 1b. FIG. 1a depicts a clean eye diagram while FIG. 1b depicts an eye diagram of a signal that is being affected by jitter. As can be seen in the jitter-affected eye diagram of FIG. 1b, the introduction of jitter into the signal increases the time period where the state of the signal level (i.e., 1 or 0) is not well defined. This problem is exacerbated as the data rate of the signal increases. An increase in data rate results in a horizontal compression of the eye diagram. This compression, combined with the introduction of jitter into a signal, can cause a significant increase in error rates if the signal is sampled on the wrong side of a transition threshold.

In systems where signal jitter and other distortions threaten to introduce higher than acceptable error rates, skilled practitioners compensate for jitter by interposing clock and data recovery (CDR) circuits along the communication path to restore and propagate the data signal such that signal jitter is significantly reduced. An example of a clock and data recovery module is depicted in FIG. 2.

FIG. 2 shows a phase-lock-loop architecture type of CDR 1. In FIG. 2, a phase comparator 20 compares the phase information provided by the level transitions of the incoming signal, with the phase of a local clock 70. Its output is a phase-error signal 30 proportional to the phase difference between the two phases. The phase-error output 30 of the comparator 20 is used to correct the frequency of the local clock 60. To achieve the desired transfer function, from the phase modulation present in the incoming signal to the residual phase modulation present in the output clock (the jitter transfer function), some low-pass filtering 40 is often added between the output 30 of the phase comparator 20 and the input 50 that controls the frequency of the local clock 60. The frequency correction 50 is then applied to the local clock 60 to generate a clock signal for data recovery 80 which matches incoming signal 10. This clock signal for data recovery 80 is then applied to incoming signal 10 to attempt to condition and propagate the signal such that jitter is significantly reduced.

The small-form-factor pluggable (SFP) is a compact optical transceiver used in optical communications for both telecommunication and data communications applications. It interfaces a network-device motherboard to a fiber-optic or unshielded-twisted-pair networking cable. It is a popular industry format supported by several fiber optic component vendors. SFP transceivers are available with a variety of different transmitter and receiver types, allowing users to select the appropriate transceiver for each link to provide the required optical reach over the available fiber type. Typically, SFPs do not include clock and data recovery circuits.

As discussed, increasing data rates require ever increasing attention to signal quality. A signal sent at a very high-data-rate which cannot be reliably read at its destination is of little value. Increased data rates require attention to signal quality at points in data paths where it was previously deemed unnecessary including very close to signal transmitters and receivers on the SFP level. In addition, there exists a need for circuits which exhibit flexibility in their ability to effectively handle a variety of data rates. This disclosure offers a solution that addresses these problems and others in describing systems and methods for optimized CDR applications for variable data rate signals for jitter reduction.

### SUMMARY

An apparatus for conditioning an optical signal capable of managing multiple data rates is disclosed that comprises a data path and a clock and data recovery circuit interposed on the data path, wherein the clock and data recovery circuit includes an input which activates the clock and data recovery circuit when a high-data-rate is present, and wherein the input bypasses the clock and data recovery circuit when a low-data-rate is present. The disclosed apparatus could be utilized as part of a transmitter or receiver.

A method of conditioning an optical signal capable of managing multiple data rates is also disclosed that comprises receiving an input data signal, determining whether the input data signal is a high-data-rate signal or a low-data-rate signal, activating a clock and data recovery circuit included on a data path of the input data signal when the data signal is a high-data-rate signal, bypassing the clock and data recovery circuit when the input data signal is a low-data-rate signal, conditioning the input data signal in the clock and data recovery circuit when the clock and data recovery circuit is activated to produce an output data signal, and propagating the output data signal.

Further, an apparatus for conditioning optical signals capable of managing multiple data rates is disclosed comprising a transmitter data path, a receiver data path, a transmitter clock and data recovery circuit interposed on the transmitter data path, wherein the transmitter clock and data recovery circuit includes a first input which activates the clock and data recovery circuit when a high-data-rate is present, and wherein said first input bypasses the clock and data recovery circuit when a low-data-rate is present. The apparatus further comprises a receiver clock and data recovery circuit interposed on the receiver data path, wherein the receiver clock and data recovery circuit includes a second input which activates the clock and data recovery circuit when a high-data-rate is present, and wherein the second input bypasses the clock and data recovery circuit when a low-data-rate is present, and an SFI interface for connecting the transmitter data path and receiver data path to a host board circuit.

### BRIEF DESCRIPTION OF THE DRAWINGS

FIG. 1a shows a depiction of a clean eye diagram.

FIG. 1b shows a depiction of an eye diagram of a signal that is being affected by jitter.

FIG. 2 shows a phase-lock-loop architecture type of a CDR.

FIG. 3 depicts a traditional SFP architecture.

FIG. 4 depicts an SFP architecture including CDR bypass control.

FIG. 5 shows a detailed view of a CDR module including a limiting amplifier in a receiver.

FIG. 6 shows a detailed view of a CDR module in a transmitter.

FIG. 7 depicts an alternate SFP architecture configuration including CDR bypass control.

FIG. 8 depicts an alternate SFP architecture configuration including only a receiver including CDR bypass control.

FIG. 9 depicts an alternate SFP architecture configuration including only a transmitter including CDR bypass control.

FIG. 10 depicts a method of conditioning an optical signal capable of managing multiple data rates.

FIG. 11 depicts a method of conditioning an optical signal capable of managing multiple data rates including a detailed breakdown of the data conditioning step.

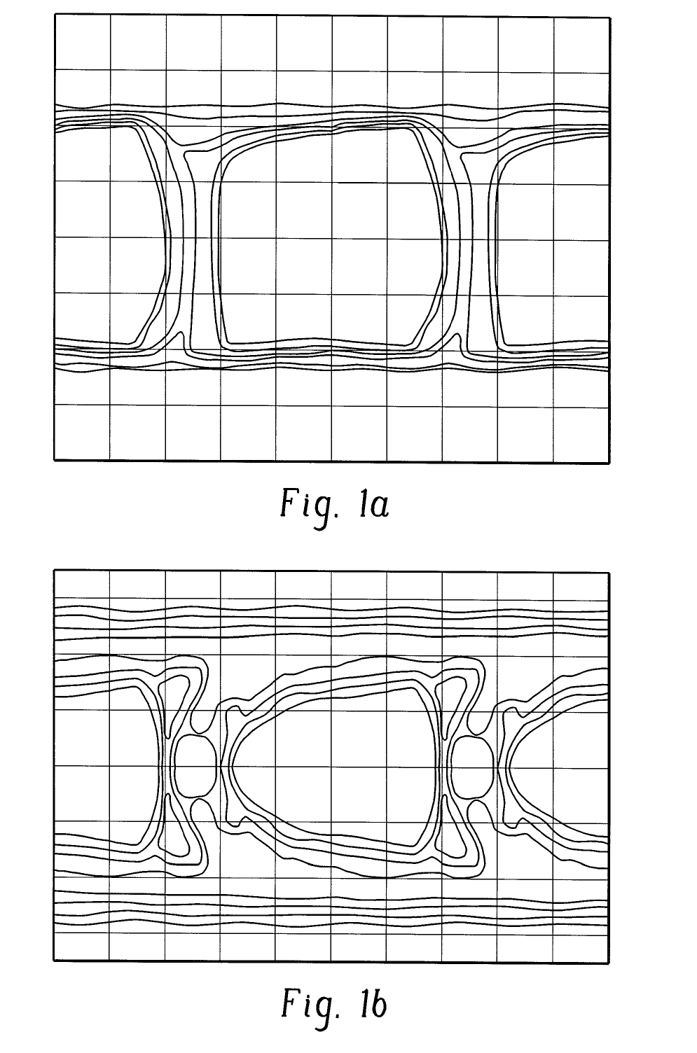

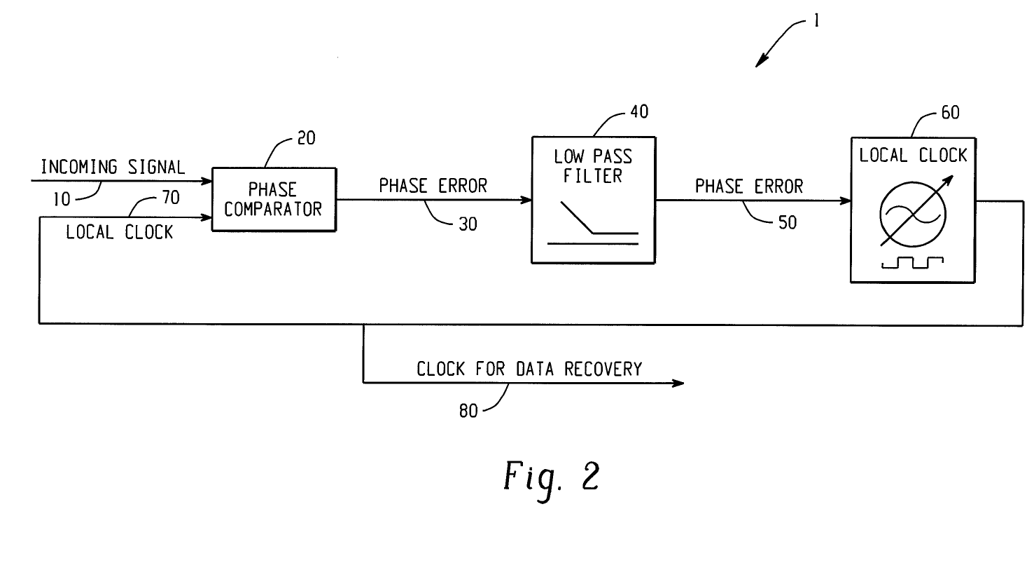

### DETAILED DESCRIPTION

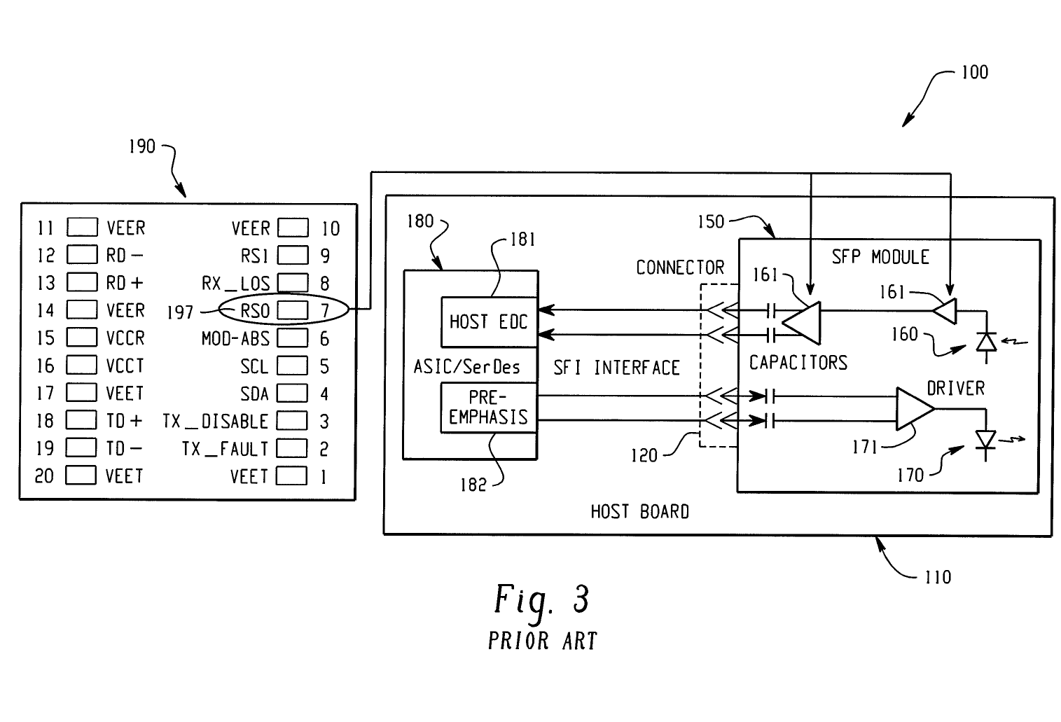

FIG. 3 depicts a traditional, prior art, SFP architecture 100. The traditional SFP architecture 100 includes a host board 110, which includes a port 120 that allows for the integration of a small-form-factor pluggable (SFP) transceiver module 150. The host board 110 also includes an application-specific integrated circuit (ASIC) Serializer/Deserializer (SerDes) 180. The ASIC/SerDes 180 converts data between serial data and parallel interfaces in each direction.

The SFP module 150 depicted in FIG. 3 includes a receiver 160 and a transmitter 170. Receiver 160 provides a received signal to a series of frequency-tuned amplifiers 161. The outputs of these amplifiers 161 are then propagated through the SFP integration port 120 to the host EDC 181 of the SerDes 180. Transmitter 170 is responsive to a driver amplifier 171. The driver amplifier 171 is responsive to the SFP integration port 120, which is in turn responsive to the pre-emphasis module 182 of the ASIC/SerDes circuit 180 included on the host board.

FIG. 3 further depicts a pinout 190 of the SFP Module connected to the host board 110. The pins depicted in pinout 190 control the functions of host board 110. Of particular note is the rate-select 0 pin, RS0 197. In the traditional SFP architecture, the rate-select pins are used to control the bandwidth of the receive path. This is done by controlling the frequency-tuned amplifiers 161 in response to the rate-select control signals. For high-data-rate signals, amplification of high-frequency signals is useful because these high-frequency signals are likely data carrying signals. In contrast, for low-data-rate signals, high-frequency components are more likely noise rather than data carrying in nature. Thus, amplification of the high-frequency components would not be worthwhile in low-data-rate cases. In response to this, frequency-tuned amplifiers 161 are made responsive to rate-select pins, such as RS0 197, so that they can be instructed to amplify only lower frequencies in low-data-rate scenarios.

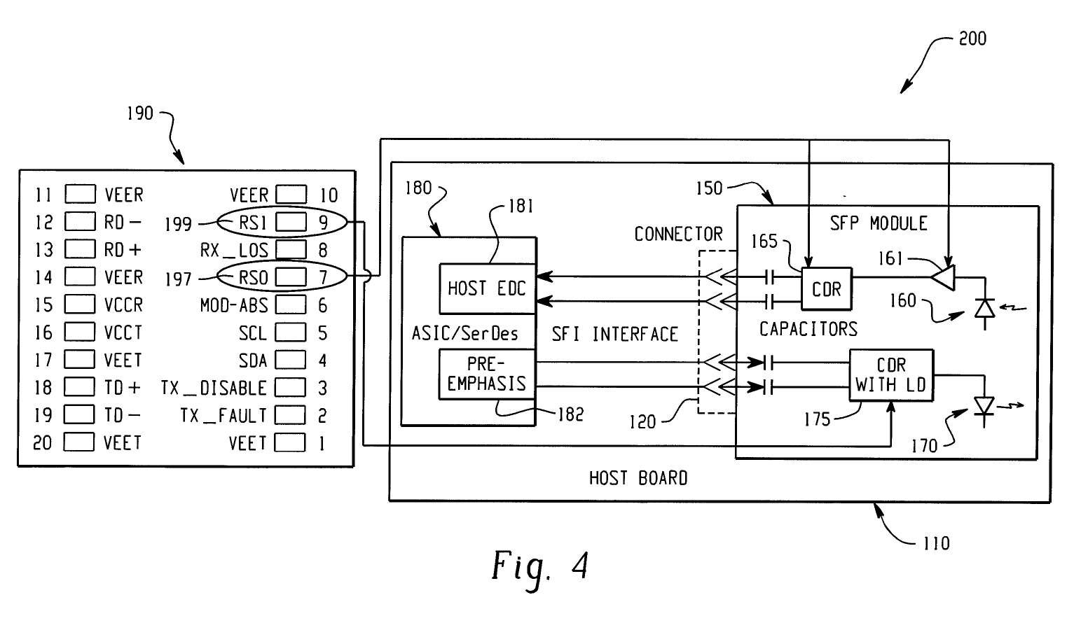

While the traditional SFP architecture depicted in FIG. 3 was adequate for prior data transmission and reception applications, as data rates continue to increase there is greater need for consideration of signal quality throughout the transmission system, including at the transceiver level. The architecture depicted in FIG. 4 discloses a system designed to compensate for the higher data-quality standards necessitated by increasing data rates, such as the next generation Fibre Channel data rate (17 Gb/s). This system also offers a high degree of flexibility enabling its effective use in applications which could present varying data rates.

FIG. 4 depicts an SFP architecture 200 including CDR bypass control. Like reference numbers have been retained from previous figures for consistency. The architecture depicted in FIG. 4 includes a CDR circuit 165 interposed on the receiver data path including the frequency-tuned amplifiers 161 and the integration port 120 connected to the host EDC 181 of the SerDes 180. The CDR 165 and the frequency-tuned amplifier 161 are responsive to the rate-select pin, RS0 197. The architecture of FIG. 4 also includes a CDR with LD module 175 on the transmitter data path between the transmitter 170 and the integration port 120 connected to the pre-emphasis module 182 of the SerDes 180.

Special note should be taken that CDR modules 165 and 175 are controlled by the standard rate-select pins 197 and 199 of SFP module 150. The use of the standard SFP pins offers increased functionality by the addition of the controlled CDR modules 165 and 175 without added control and fabrication complexity of additional control pins.

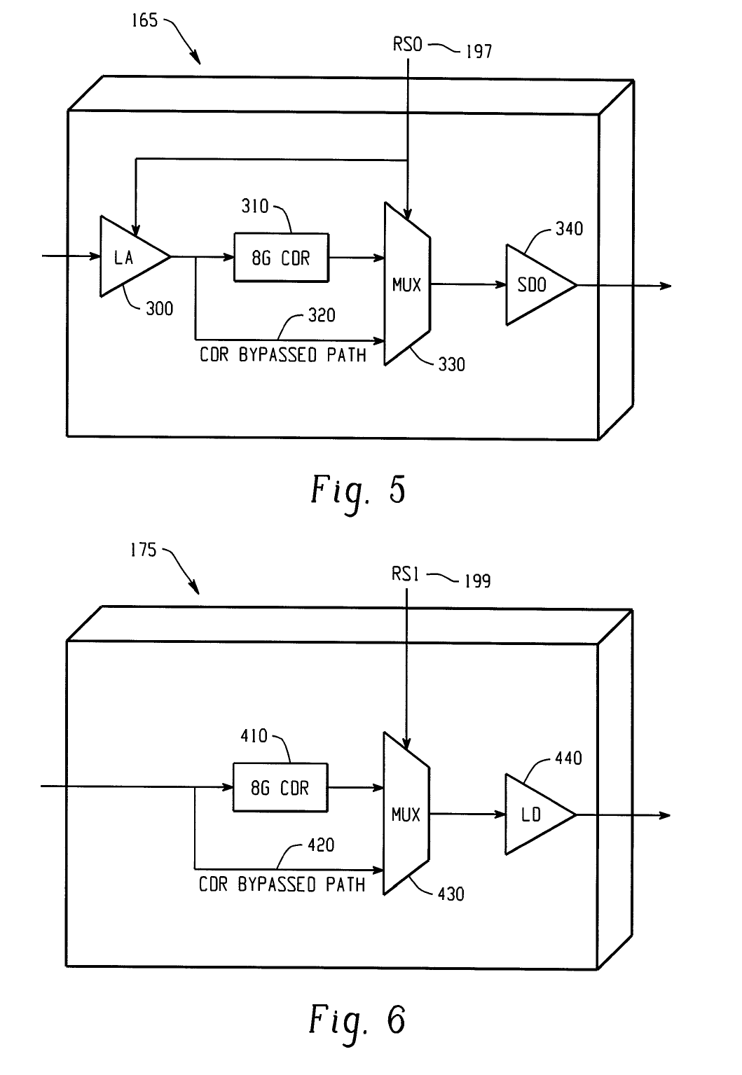

FIG. 5 shows a detailed view of a CDR module 165 including a limiting amplifier 300 in a receiver. The limiting amplifier 300 is responsive to rate-select pin RS0 197 and receives a data signal from the receiver 160. Limiting amplifier 300 is a high-pass or band-pass filter having an frequency amplification range controlled by rate-select pin RS0 197. The CDR module 165 also includes an 8-gigabit CDR 310 responsive to the output of the limiting amplifier 300. Further, the CDR module 165 includes a multiplexer 330. Multiplexer 330 is receptive to inputs from CDR 310 as well as from the limiting amplifier 300 along the CDR bypassed path 320. Multiplexer 330 is responsive to rate-select pin RS0 197 for determining the appropriate output to propagate to the Serial-Data-Output (SDO) amplifier 340. Amplifier 340 propagates the data signal through integration port 120 to the SerDes 180.

As depicted in FIG. 5, limiting amplifier 300 and multiplexer 330 are responsive to rate-select pin RS0 197 as depicted in Table 1, below. In one example embodiment, when a high-data-rate is being received, rate-select pin RS0 197 instructs the limiting amplifier 300 and multiplexer 330 by asserting a ‘1’ control signal. Conversely, in low-data-rate applications, RS0 197 asserts a ‘0’ control signal. (It is easily recognized by one skilled in the art that negative logic could easily be substituted as well as other variations in circuit layout and composition).

TABLE 1
Receiver CDR Module Rate Response Table
Receiver CDR Module Rate Response Table

| | Rate-select | | |
|---|---|---|---|
| Data Rate | Pin RS0 State | Limiting Amplifier | Multiplexer Selection |
| High | 1 | High-Bandwidth | CDR Path |
| Low | 0 | Low-Bandwidth | CDR Bypassed Path |

Upon receipt of a ‘1’ control signal from RS0 197, limiting amplifier 300 enters a high bandwidth mode wherein high-frequency data signals are amplified. This is advantageous because during high-data-rate applications, the high-frequency signals which limiting amplifier 300 is designed to amplify are usually data carrying. This amplification of data carrying frequencies expands the eye diagram of the data signal vertically, potentially offering marked improvement in the opening of the eye. In addition to turning on limiting amplifier 300, a ‘1’ signal from RS0 197 instructs multiplexer 330 to select the output of CDR 310 for propagation. The output from CDR 310 is selected for high-data-rate applications because high-data-rate applications result in an increased risk of bit errors due to the narrowing of the signal eye diagram as discussed previously. This heightened risk of bit errors creates a need for signal quality control at all levels of the data path, including at the transceiver level. Small noise at one point in the data path can be propagated and magnified into significant noise resulting in unsatisfactory error rates. Thus, as data rates increase, additional signal conditioning elements may need to be used in order to preserve signal integrity. A clock and data recovery circuit can meet this need by removing jitter and distortion in the data stream and retiming it for further processing.

At lower data rates, however, the utilization of circuit elements beneficial for high-data-rates becomes disadvantageous. For example, at low-data-rates the activation of limiting amplifier 300 in a high bandwidth mode would not be helpful. This is because for low-data-rate signals, higher frequency signals are not primarily the data carrying frequencies. High frequencies present in low-data-rate signals often tend to be noise. Thus, a high-frequency amplifier, such as limiting amplifier 300, would tend to magnify noise more than data-rich frequencies. Because of this, limiting amplifier 300 is made responsive to rate-select pin RS0 197. As depicted in Table 1, when receiving a low-data-rate signal, RS0 197 asserts a ‘0’ signal. In response to this ‘0’ signal, the limiting amplifier 300 functions in a low-bandwidth mode where lower frequencies more likely to be carrying data signals are amplified.

Additionally, a ‘0’ signal from RS0 197 during a low-data-rate transmission instructs multiplexer 330 to select the signal from CDR bypassed path 320 for propagation. CDR 310 is bypassed in scenarios presenting low-data-rates because the advantages introduced by CDR 310 are not necessary at low-data-rates and disadvantages, which are dwarfed by the benefits gained during high-data-rate modes, are now significant enough when compared to the low-data-rate advantages to tip the balance in favor of bypassing the CDR 310. This tipping of the balance is in large part due to the horizontal expansion of the eye diagram of the data signal due to the decreased data rate. This horizontal expansion allows the transient jitter portions of the data signal to settle prior to the optimum sampling time. Thus, signal conditioning requirements are diminished because the slow bit rate allows sampling following a longer signal settling period, enabling the bypassing of the CDR 310 to avoid its inherent disadvantages.

Disadvantages of continuous use of CDR 310 include issues such as power consumption and CDR negotiation and lock time. Clearly, continual activation of CDR 310 will result in a power drain on the system as CDR 310 includes complex, powered, active circuit elements which could include components such as phase locked loops as discussed earlier. The continued utilization of these powered elements when the signal quality improvements are not needed is a waste of energy resources. Thus, the CDR elements may be disabled during bypass. Additionally, there is a performance concession implicit in the use of CDR 310 in negotiation and settling of the CDR when data rates transition resulting in loss of usable data transfer time. While these disadvantages are clearly outweighed in high-data-rate applications where the signal conditioning is highly beneficial, the ability to bypass CDR 310 to avoid these disadvantages in situations where the gains from conditioning in CDR 310 are small results in a significant benefit.

FIG. 6 shows a detailed view of a CDR module in a transmitter. The CDR module 175 includes an 8-gigabit CDR 410 responsive to a data signal from the ASIC/SerDes 180 pre-emphasis module 182 routed through integration port 120. Further, the CDR module 175 includes a multiplexer 430. Multiplexer 430 is receptive to inputs from CDR 410 as well as from the pre-emphasis module 182 through integration port 120 along the CDR bypassed path 420. Multiplexer 430 is responsive to rate-select pin RS1 199 for determining the appropriate output to propagate to laser driver 440. Laser driver 440 propagates the data signal to transmitter 170.

CDR module 175 functions in a similar fashion to CDR module 165, but in a transmitting direction. Limiting amplifiers are not present in this example to illustrate an alternative configuration. Amplifiers could be present in either a transmitter or receiver CDR configuration as desired. As illustrated in FIG. 6, multiplexer 430 is responsive to a rate-select pin from the host board. In the case depicted in FIG. 6, multiplexer 430 is responsive to the rate-select 1 pin RS1 199. For the same reasons discussed previously concerning the receiver CDR module 165, the multiplexer 430 in the transmitter CDR module 175 is instructed to propagate a signal from either CDR 410 or the CDR bypass path 420 based upon instruction from a rate-select pin.

In one example embodiment, when a high-data-rate is being received, rate-select pin RS1 199 instructs multiplexer 430 by asserting a ‘1’ control signal. Conversely, in low-data-rate applications, RS1 199 asserts a ‘0’ control signal as depicted in Table 2.

TABLE 2
Transmitter CDR Module Rate Response Table
Transmitter CDR Module Rate Response Table

| Data Rate | Rate-select Pin RS0 State | Multiplexer Selection |
|---|---|---|
| High | 1 | CDR Path |
| Low | 0 | CDR Bypassed Path |

As depicted in Table 2, a ‘1’ signal from RS1 199 instructs multiplexer 430 to select the output of CDR 410 for propagation. The output from CDR 410 is selected for high-data-rate applications. High-data-rate applications result in an increased risk of bit errors due to the narrowing of the signal eye diagram as discussed previously. Again, this heightened risk of bit errors creates a need for signal quality control at all levels of the data path including at the transceiver level. Small noise at one point in the data path can be magnified into significant noise resulting in unsatisfactory error rates. Thus, as data rates increase, additional signal conditioning elements may need to be used in order to preserve signal integrity.

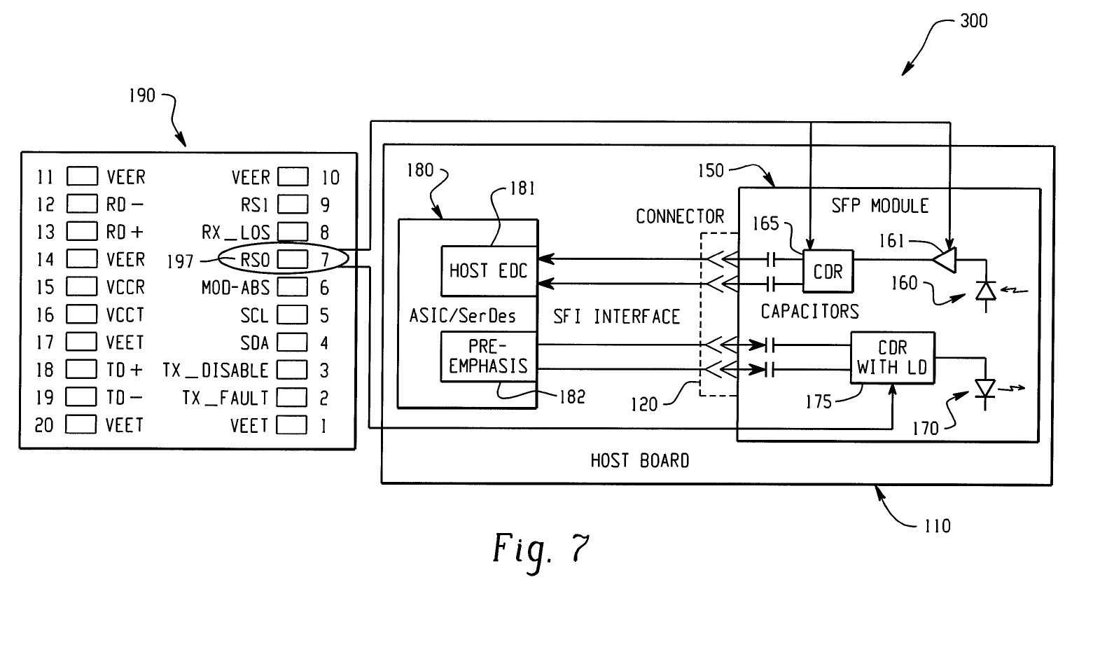

It should be noted that one skilled in the art would be able to achieve results commensurate with the spirit of this disclosure despite minor variation in system structure. For example, FIG. 7 depicts an alternate SFP architecture configuration 300 including CDR bypass control. In this configuration, CDR receiver module 165 and limiting amplifier 161 are controlled by rate-select pin RS0 197 in a similar manner as depicted in FIG. 4. However, in this configuration, the transmitter CDR module 175 is also controlled by RS0 197.

The configuration of FIG. 7 offers an improvement in simplicity of circuit design and fabrication while conceding some operation flexibility. If data transmitting and receiving rates are synchronized, then the configuration of FIG. 7 is advantageous in that only one rate-select pin, RS0 197, needs to be controlled and toggled. In FIG. 7, rate-select pin RS0 197 controls the data rate modes of both CDR modules 165 and 175. This is in contrast to the embodiment of FIG. 4 where rate-select pins RS0 197 and RS1 199 individually control CDR modules 165 and 175, respectively. Synchronization does not require an exact matching of transmitting and receiving data rates. It only requires that the transmitting and receiving portions of the SFP module 150 operate in matching high or low-data-rate modes. The configuration of FIG. 7 offers the benefit of simplified control. However, in applications where transmitting and receiving data rates are independent, performance may be suboptimal when high-data-rate transmitting and low-data-rate receiving modes are desired and vice versa.

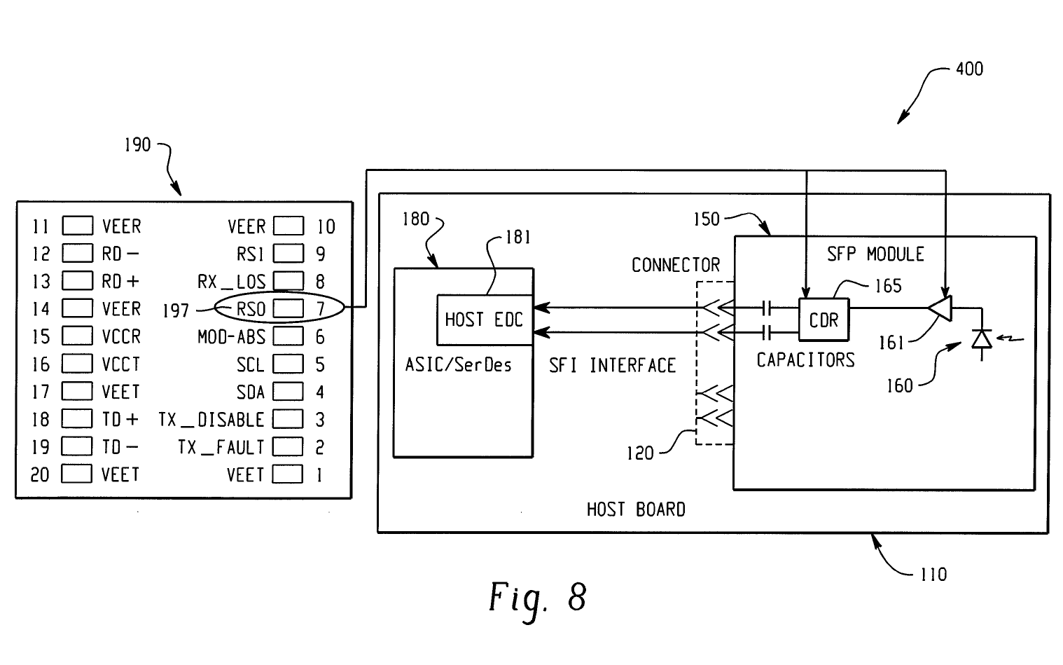

Another alternative embodiment is depicted in FIG. 8. FIG. 8 depicts an alternate SFP architecture configuration 400 including only a receiver having CDR bypass control. Similar to previous figures, CDR module 165 is controlled by rate-select pin RS0 197. This configuration could similarly be controlled by other included rate-select or other pins. This configuration offers simplicity and cost savings if transmission capabilities are not necessary while still offering the capabilities and flexibility of bypassable CDR technology for effectively handling high-data-rates or low-data-rates.

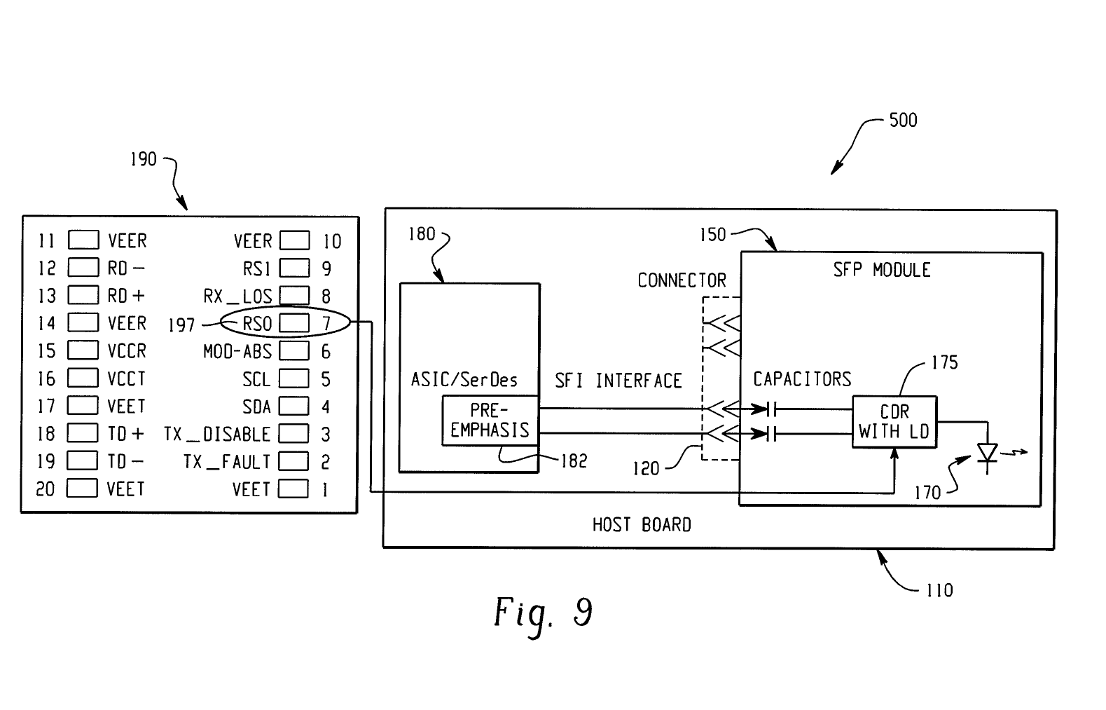

Similarly, another alternative embodiment is depicted in FIG. 9. FIG. 9 depicts an alternate SFP architecture configuration 500 including only a transmitter having CDR bypass control. Similar to previous figures, CDR module 175 is controlled by rate-select pin RS0 197. This configuration could similarly be controlled by other included rate-select or other pins. This configuration offers simplicity and cost savings if reception capabilities are not necessary while still offering the capabilities and flexibility of bypassable CDR technology for effectively handling high-data-rates or low-data-rates.

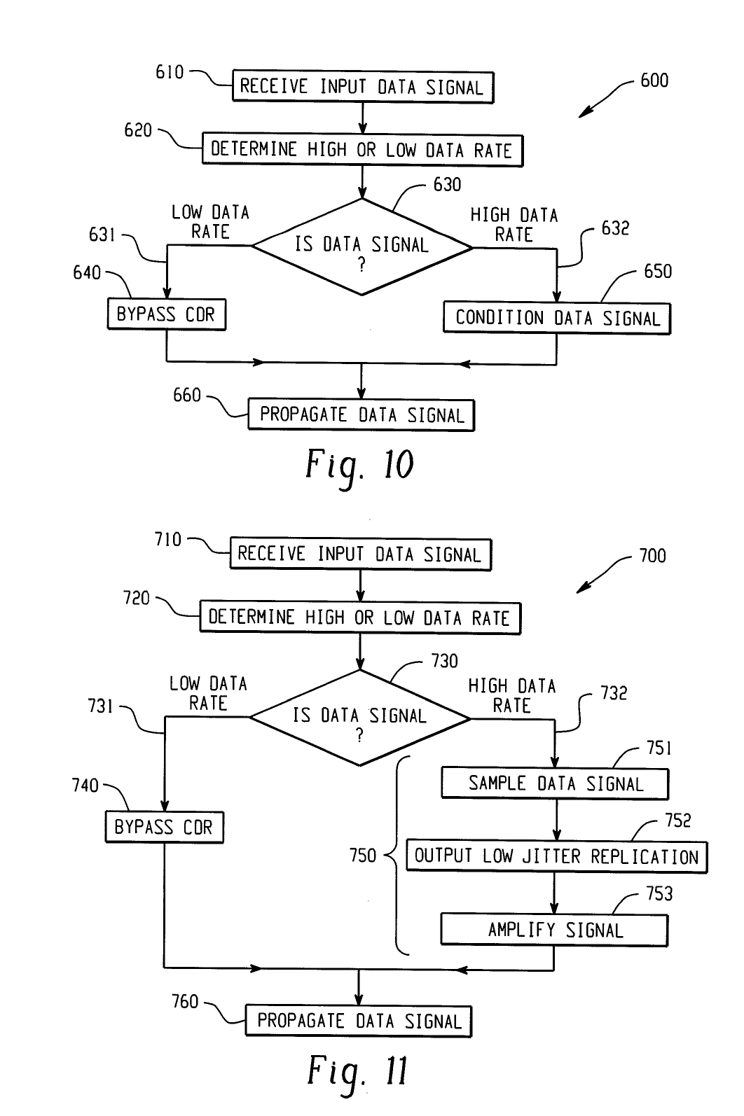

FIG. 10 depicts a method of conditioning an optical signal 600. This method 600 begins with step 610 where an input data signal is received. It is then determined whether the received data signal is a low-data-rate signal or a high-data-rate signal 620. Once this determination is made, a decision is made in step 630. If the signal is a low-data-rate signal, branch 631 is taken and the clock and data recovery circuit is bypassed in step 640. However, if the data signal is a high-data-rate signal, the data signal is conditioned through the clock and data recovery circuit in step 650. Regardless of the branch taken, after one of steps 640 and 650 is taken, the data signal is propagated at step 660.

FIG. 11 depicts a method of conditioning an optical signal capable of managing multiple data rates with a detailed breakdown of the data conditioning step. This figure is similar to FIG. 10, but with more details on the conditioning stage 750. In the conditioning stage 750 data may be conditioned by sampling the data in stage 751, outputting a low-jitter replication of the input data signal in step 752, and amplifying the signal in step 753. It should be noted that steps 751-753 could be executed in any order, and it is not required that any/all of the steps be completed for successful conditioning to occur.

While examples have been used to disclose the invention, including the best mode, and also to enable any person skilled in the art to make and use the invention, the patentable scope of the invention is defined by claims, and may include other examples that occur to those skilled in the art.

We claim:

1. An apparatus for conditioning an optical signal capable of managing multiple data rates on a SFP module, comprising:
a data path located in the SFP module; and
a clock and data recovery circuit interposed on the data path;
wherein the clock and data recovery circuit includes an input which activates the clock and data recovery circuit when a high-data-rate is present, and wherein the input bypasses the clock and data recovery circuit when a low-data-rate is present;
wherein the input is responsive to a rate-select pin of the SFP module.

2. The apparatus of claim 1, wherein the apparatus is a data transmitter.

3. The apparatus of claim 1, wherein the clock and data recovery circuit comprises:
a CDR module responsive to the data path; and
a multiplexer responsive to an output of the CDR module, the data path, and the rate-select pin of the SFP module.

4. The apparatus of claim 3, wherein the CDR module selection signal is active when a high-data-rate is present causing the multiplexer to propagate the output signal of the CDR module and wherein the CDR module selection signal is inactive when a low-data-rate is present causing the multiplexer to propagate the data path signal.

5. The apparatus of claim 4, wherein the clock and data recovery circuit further comprises a limiting amplifier interposed on the data path before the CDR module and the multiplexer;
wherein the limiting amplifier is responsive to the CDR module selection signal such that the limiting is high bandwidth when a high-data-rate is present and the limiting is low bandwidth when a low-data-rate is present.

6. The apparatus of claim 5, further comprising an SFI interface connecting the apparatus data path to a host circuit board.

7. The apparatus of claim 5, further comprising a laser driver responsive to the multiplexer.

8. The apparatus of claim 1, wherein the apparatus is a data receiver.

9. The apparatus of claim 8, wherein the clock and data recovery circuit comprises:
a CDR module responsive to the data path; and
a multiplexer responsive to an output of the CDR module, the data path, and the rate-select pin of the SFP module.

10. The apparatus of claim 9, further comprising a driver responsive to the multiplexer.

11. The apparatus of claim 10, further comprising an SFI interface connecting the driver to a host circuit board.

12. A method of conditioning an optical signal capable of managing multiple data rates on a SFP module, comprising:
receiving an input data signal;
determining whether the input data signal is a high-data-rate signal or a low-data-rate signal;
activating a clock and data recovery circuit included on a data path of the input data signal when the data signal is a high-data-rate signal;
bypassing the clock and data recovery circuit when the input data signal is a low-data-rate signal;
wherein the activating a clock and data recovery circuit and bypassing the clock and data recovery circuit is controlled by a rate-select pin in the SFP module in response to determining whether the input data signal is a high-data-rate signal or a low-data-rate signal;
conditioning the input data signal in the clock and data recovery circuit when the clock and data recovery circuit is activated to produce an output data signal; and
propagating the output data signal.

13. The method of claim 12, wherein the conditioning of the input data signal in the clock and data recovery circuit reduces signal jitter by sampling the received data signal and outputting a low-jitter replication of the input data signal as an output data signal.

14. The method of claim 13, wherein the conditioning of the input includes amplification of the data signal.

15. The method of claim 13, wherein the conditioning is done during data transmission.

16. The method of claim 15, wherein the propagating is accomplished by an optical data transmitter.

17. The method of claim 13, wherein the conditioning is done during data receipt.

18. An apparatus for conditioning optical signals capable of managing multiple data rates on a SFP module comprising:
a transmitter data path in the SFP module;
a receiver data path in the SFP module;
a transmitter clock and data recovery circuit interposed on the transmitter data path;
wherein the transmitter clock and data recovery circuit includes a first input which activates the clock and data recovery circuit when a high-data-rate is present, and wherein said first input bypasses the clock and data recovery circuit when a low-data-rate is present;
wherein the first input is responsive to a first rate-select pin of the SFP module;
a receiver clock and data recovery circuit interposed on the receiver data path;
wherein the receiver clock and data recovery circuit includes a second input which activates the clock and data recovery circuit when a high-data-rate is present, and wherein said second input bypasses the clock and data recovery circuit when a low-data-rate is present;
wherein the second input is responsive to a second rate-select pin of the SFP module;
an SFI interface for connecting the apparatus to a host circuit board;

19. The apparatus of claim 18, wherein the first input and the second input are controlled by the same rate-select pin of the SFP module.

20. The apparatus of claim 9, wherein the clock and data recovery circuit further comprises:
a limiting amplifier responsive to the rate-select pin of the SFP module;
wherein the limiting amplifier is directed to amplify high-frequency signals when a high-data-rate is present.

21. The apparatus of claim 18, wherein the receiver clock and data recovery circuit comprises:
a CDR module responsive to the receiver data path;
a multiplexer responsive to an output of the CDR module, the receiver data path, and the second rate-select pin of the SFP module; and
a limiting amplifier responsive to the receiver data path and the second rate-select pin of the SFP module;
wherein the limiting amplifier is directed to amplify high-frequency signals when a high-data-rate is present.

22. The apparatus of claim 1, wherein the clock and data recovery circuit is powered down when bypassed.

23. The apparatus of claim 18, wherein the transmitter clock and data recovery circuit and receiver clock and data recovery circuit are powered down when each is bypassed.

24. The apparatus of claim 1, wherein the data path supports a 17 Gb/s fibre channel data rate.
